(19) United States
(12) Patent Application Publication
(10) Pub. No.: US 2006/0092320 A1
(43) Pub. Date: May 4, 2006

(54) Transferring a video frame from memory into an on-chip buffer for video processing

(76) Inventors: Brian R. Nickerson, Hillsboro, OR (US); Samuel Wong, Richmond Hill (CA); Sunil Chaudhari, Milpitas, CA (US); Jonathan W. Liu, Campbell, CA (US); Sreenath Kurupati, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/977,057

(22) Filed: Oct. 29, 2004

(51) Int. Cl. H04N 7/01; H04N 11/20

(52) U.S. Cl. 348/441

(57) ABSTRACT

A portion of a video frame is transferred via a memory burst transfer, from memory to an on-chip buffer. The on-chip buffer has a width that is the same as the memory burst width for the memory. Video processing is performed upon the transferred portion. Other embodiments are also described and claimed.

### BACKGROUND

There are several stages of digital processing that are performed on input video, before obtaining the final pixels of an image or frame that is then applied to a display screen. Most digital video players can interface with different types of video sources, including different broadcast and video coding formats, for example National Television Standards Committee, NTSC, and Motion Picture Experts Group, MPEG, formats. A converter is therefore typically provided in an initial stage, to perform a conversion from an NTSC analog signal or an MPEG digital signal, into an uncompressed digital video stream. This stream is then fed to an integrated circuit (IC) referred to here simply as a digital television (TV) chip. The digital TV chip is often physically located inside a personal computer (PC), a television set-top box, or the display device.

The digital TV chip has a display processing engine (DPE), also referred to as a video pipeline or a display processing pipeline. The DPE receives the uncompressed video stream, and processes the stream to make it suitable for a particular display device. The DPE also has a number of stages. One of these stages may perform noise reduction. Another enhances the stream, e.g. with respect to sharpness or contrast. Both may be designed to improve how the stream will appear when displayed. The DPE may also have a format adjustment stage. The format adjustment stage changes the resolution of the video stream, its refresh rate, and/or its scan rate, to suit a particular type of display device (such as a high definition television, HDTV, display device, liquid crystal display (LCD), plasma, and cathode ray tube (CRT)).

A video stream is received by the DPE typically in raster scan order, e.g. transferred from external memory in the order of the horizontal lines of the display screen as they are scanned left to right (or right to left), top to bottom (or bottom to top). The external memory may include off-chip, random access memory (RAM) devices, such as dynamic RAM devices. The memory devices may be part of the main or system memory of a PC, such as one that uses a PENTIUM® processor by Intel Corp., Santa Clara, Calif. The enhanced stream may then be forwarded by the DPE directly to the display device.

Format adjustment by the DPE may be performed in part by a scaling stage. The scaling operation is designed to shrink or expand the video frames in horizontal and/or vertical directions. In some applications, such as converting from an older, broadcast television standard to HDTV, the scaling operation needs to be of finer granularity. Fine granularity scaling is typically performed using a special type of digital filter called a polyphase filter.

A DPE may implement vertical scaling, i.e. stretching or shrinking in the vertical direction of a frame, using a polyphase filter, as follows. Consider a DPE that has five, local (on-chip) line memories, each being large enough to store the pixels of an entire horizontal line of an image or frame that fills the entire display screen. An output from each of the five line memories is coupled to a 5-tap (five input) polyphase filter. The polyphase filter produces a single pixel value at its output, for every column of five input pixels, obtained from the line memories. Consistent with raster scan order, the DPE typically loads five complete rows of the image or frame sequentially, from off-chip memory into its line memories. Once the line memories have been loaded, the polyphase filter output is enabled and taken as a new set of pixel values (for the scaled image). Note that depending on the magnitude of the downscaling or upscaling, the DPE may need to read additional rows of the frame into its line memories (which may replace ones that were read earlier), to generate greater or fewer output pixels for the scaled image.

As an example of the above technique, consider video having 1920×1080 pixel resolution (suitable for HD television). Each line memory in that case is about 2000 pixels wide, to fit a complete row of 1920 pixels (the horizontal width of the frame). Thus, for a 4:2:2 Y-Cr-Cb color configuration at 8 bits/pixel, this operation requires the following line memory sizes:
line memory for Y=5×1920×8=76,800 bits
line memory for Cr=5×1920/2×8=38,400 bits
line memory for Cb=5×1920/2×8=38,400 bits
line memory total=153600 bits.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 is a block diagram of an environment for video processing.

FIG. 2 shows an example HD frame that has been divided into a number of strips or regions to be sequentially transferred to an on-chip buffer for video processing.

FIG. 3 is a block diagram of a system containing a processor and a video post-processing chip.

FIG. 4 is a flow diagram of a method for processing video.

### DETAILED DESCRIPTION

An embodiment of the invention is directed to techniques for vertical scaling of digital images or digital video using polyphase filters. Other embodiments are also described.

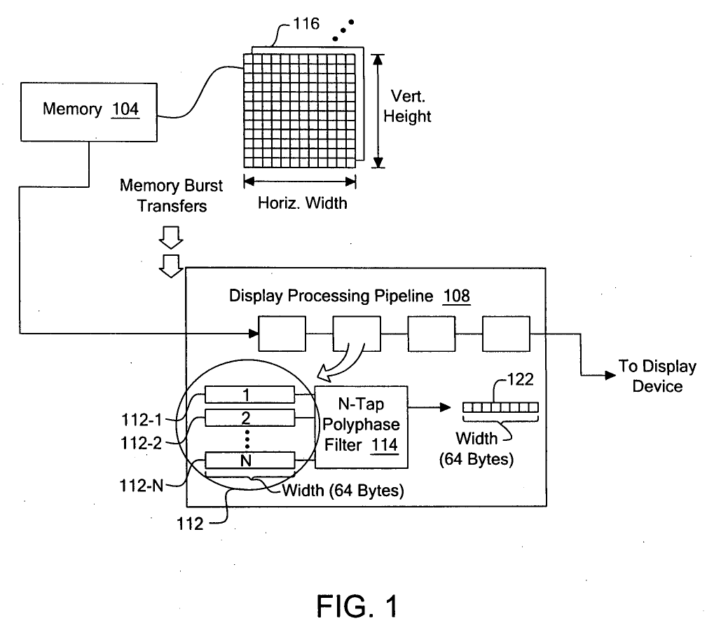

FIG. 1 is a block diagram of an environment for video processing, according to an embodiment of the invention. The video that is to be displayed arrives and is stored as a stream of decoded, uncompressed frames 116 in a memory 104. The memory 104 in this case is off-chip memory, but it may alternatively be located on-chip. The memory 104 may be one that is large enough to store a full size frame, e.g. a full size frame buffer. A separate digital television (DTV) chip 108 performs video processing upon the frames, using a combination of hardware and/or firmware that constitute a video pipeline or display processing pipeline as described above. The frames 116 are transferred in portions, from the memory to the DTV chip where video processing is performed upon them. Once a portion has been processed, the results may then be subsequently transferred back to the memory, or to another location, for being applied to the display screen (not shown). The DTV chip hardware includes an on-chip buffer 112 that is to store portions of each video frame that is being processed. The video processing may include scaling performed using an N tap, polyphase filter 114.

The transfer of video frame pixel data from the memory, to fill the on-chip buffer 112 of the DTV chip for processing, may occur in multiple memory transactions, e.g. multiple memory burst transfers. For example, the memory 104 may include double data rate (DDR) random access memory (RAM) for which there is a well defined mechanism for memory burst transfers. Burst transfers are aligned with certain memory address boundaries. For example, a burst may be word aligned, that is the burst includes an integer number of words starting at a given address (where each word includes two or more bytes). Alternatively, the burst transfer may be aligned with larger or smaller chunks of memory. A memory burst transfer is more efficient than transferring the same number of words using multiple, smaller transactions.

Operation of the environment depicted in FIG. 1 may be as follows. The operations described here may be performed sequentially on each frame. A video frame 116 that is stored in the memory 104 is divided into a number of strips or regions. Each strip has a width (measured in pixels) that may be less than one-half a full horizontal screen width. Each strip may be an integer multiple (one or greater) of a memory burst width (or also referred to as memory burst size) for the memory. Pixel data may be transferred from memory in portions that are strip-sized (from a width standpoint). This helps reduce transaction overhead associated with transfers from memory.

If the strip width is an integer multiple of the width of the buffer 112 and an integer multiple of the burst size, then memory access penalties associated with reading excess data beyond what is needed to fill the buffer (which data is essentially discarded) are thus avoided, so that memory transfer cycles are saved. This savings becomes more significant with larger frames (e.g., HD frames), and higher frame rate for high quality video (e.g., more than 30 frames per second).

In addition to the savings in overhead associated with memory transactions, an embodiment of the invention allows for reduced on-chip buffer or line memory size, thereby reducing the chip real estate needed for video processing. For example, taking the case of 1920×1080 HD video described in the Background section above, the line memory size needed using an embodiment of the invention is as follows (for the example of a 5 tap polyphase filter, and 4:2:2 Y, Cr, Cb color configuration, and 8 bits/pixel):
line memory for 4Y=5*64*8=2,560
line memory for Cr=5*64*8=2,560
line memory for Cb=5*64*8=2,560
line memory total=7680 bits
   where each line memory is only 64 bytes wide. Thus, there is a savings in the local or on-chip line memory size of more than an order of magnitude.

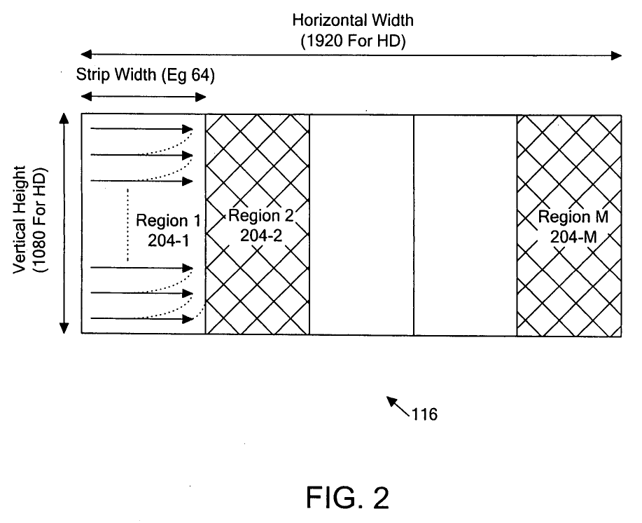

Referring now to FIG. 2, an example frame 116 (1920×1080 pixel resolution for HD television) is shown that has been divided into M strips or regions 204. Each strip width is the same in this case, in this example, 64 bytes, except for a strip at the far right or far left edge of the frame (not shown). In other embodiments, the frame may be divided into sections of different strip widths. FIG. 2 also shows how portions of the strip are read one horizontal line at a time, in a partial raster scan order, left to right in this case and top to bottom. Alternatively, the raster scan order may be right to left and/or bottom to top. Each strip may be processed in order, by the DTV chip 108 (FIG. 1). Note that some of the strips may overlap, although for better performance, they should be non-overlapping and aligned as, for example, shown in FIG. 2, so there is no gap between adjacent strips or regions 204.

Returning to FIG. 1, the video processing that is performed in the DTV chip 108 upon a transferred portion of a strip uses a polyphase filter 114. The polyphase filter is a digital filter that has N taps. When implementing vertical scaling using a polyphase filter, the on-chip buffer 112 may include N line memories 112_1, 112_2, . . . , 112_N for each color or luminance component of the video. In this case, N horizontal line segments are stored in the on-chip buffer at a time. It should be noted these are line segments, as opposed to complete or entire lines of a video frame that fills the entire display screen. With typical raster scan transfers, the complete line would have been required to be transferred to the on-chip buffer.

To produce an initial output by the polyphase filter, an initial set of N line segments would need to be read from a given strip or region 204 (see FIG. 2). Once that has been performed, the output of the polyphase filter is taken in a horizontal line fashion. For instance, in this case, there is an output line segment 122 that includes 64 bytes taken from the polyphase filter, for each group of N line segments each 64 bytes wide that have been loaded. Depending on the scaling factor in the case of vertical scaling, one or more additional or new line segments would need to be loaded after the initial set has been processed. Thus, although one portion of a strip may include N line segments, a subsequent portion may be just a single additional line segment. In this manner, a window of N line segments is being fed to the polyphase filter that moves vertically down the strip, providing a 64 byte wide output line segment at each position. After the entire first region 204_1 has been processed, the operation moves to region 204_2, and sequentially through the rest of the frame in that fashion. Note that a new set of digital filter coefficients may optionally be loaded at each position of the window.

In general, the strip width may be selected to make efficient transfers to the on-chip buffer, based on the memory bus width. For example, the strip width may be an integer multiple of a memory burst size. It has been determined, however, that with external memory, the line memory width need not be more than a single memory burst width. Keeping each line memory width exactly equal to a single memory burst width avoids access penalties associated with unaligned memory reads, but may also be a desirable tradeoff between chip real estate and greater buffering. As an example, for 64 bit DDR memories and 8-bit pixels, the strip width should be 64 bytes, with a burst size of 8 bytes, and a line memory width in the on-chip buffer of 8 bytes.

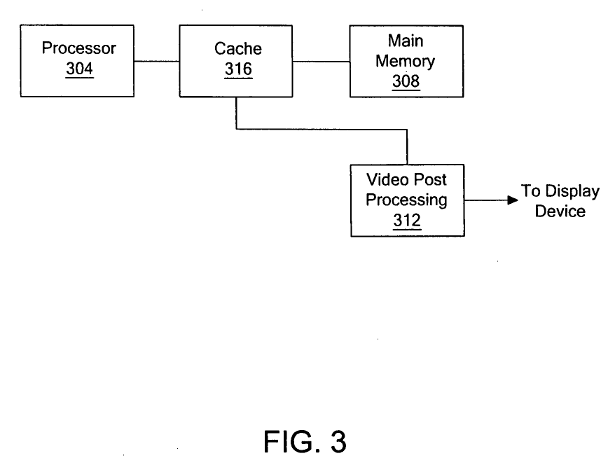

Turning now to FIG. 3, a block diagram of a computer system with a video post-processing chip is shown. The system has a processor 304, which may be a PENTIUM® Processor by Intel Corp., of Santa Clara, Calif. Main memory 308, including, for example, DDR RAM modules is to store a program that is to be executed by the processor. A video post-processing chip 312 is to perform frame adjustment upon decoded video that has been requested by the program. This decoded video may be, for example, decoded MPEG video or another source of raw video that has been digitized. The chip 312 is to “divide” or “partition” the frame into strips, i.e. access each video frame in the form of strips, as explained above, where each strip may have a width that is an integer multiple of a memory burst width for the main memory 308. As an alternative, each strip width may be an integer multiple of a cache line for a cache 316, where the cache 316 is to store data recently used by the processor. The chip 312 has a mechanism that allows each strip to be transferred sequentially from main memory into the chip 312, where it is then vertically scaled. This is an example of a unified memory architecture embodiment, where the main memory 308 has a frame buffer section to store the video frames for transfer to the post-processing chip 312. Such video frames may be stored in the frame buffer section in raster scan order. In other words, they may be written to the frame buffer section in raster scan order, as well as read from it in raster scan order. Of course, for purposes of vertical scaling, however, the frames are not read entire lines at a time, but rather one strip at a time (also referred to here as partial raster scan).

The transfer may be implemented by a direct memory access (DMA) channel that links the chip 312 to the main memory. As to vertical scaling, this may be performed, as described above, by a polyphase filter with N taps, each tap being coupled to a respective on-chip line segment buffer. The on-chip buffer is to store up to N line segments of a strip, where each line segment buffer may be of the same width as the memory burst width.

According to another embodiment of the invention, the frame buffer memory is on-chip with the polyphase filter and its on-chip/local buffer. In that case, the on-chip buffer may be part of the scratch memory that is typically inside an on-chip DMA engine.

The vertical scaling as mentioned above is implemented by an n-input, one-dimensional operator. In that case, an output pixel of the operator depends on a column of n pixels, and not on those of neighboring columns. The entire frame may be processed in this manner during a first pass. This may be combined with a second pass in which another one-dimensional operator is applied, this time for horizontal scaling. The combination of the two passes achieves the desired two-dimensional scaling. An application of this type of format adjustment is the conversion from NTSC 4:3 to HD 16:9 (via two-dimensional, anamorphic scaling).

Also, there may be more than one input video stream that is fed to the display processing pipeline of the DTV chip. For example, one stream is to be shown full screen on a television display device while another is to be shown as a picture-in-picture (PIP) or as a picture-over-picture (POP), on the same display screen.

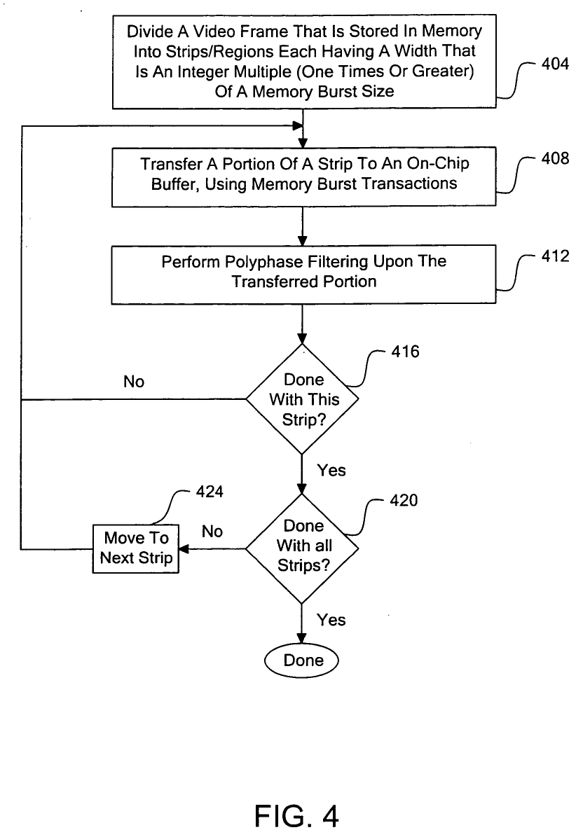

Referring now to FIG. 4, a flow diagram of a method for post-processing of decoded video, according to an embodiment of the invention, is shown. Operation begins with dividing a video frame that is stored in frame buffer memory into strips or regions, each having a width that is an integer multiple of a memory burst size (404). A portion of a strip is transferred to an on-chip buffer, using memory burst transactions (408). Polyphase filtering, e.g. vertical anamorphic scaling, may be performed upon the transferred portion (412). If that portion was the last one of the given strip (416), then the method determines whether all of the strips have been processed (420). If not, the method moves to either the next portion or the next strip (424), and the transfer and polyphase filtering operations 408, 412 are repeated for multiple portions of that next strip.

An embodiment of the invention may be a machine readable medium having stored thereon instructions which program a processor to perform some of the operations described above, e.g. performing image processing such as vertical scaling upon image portions that have been transferred from memory. In other embodiments, some of these operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), not limited to Compact Disc Read-Only Memory (CD-ROMs), Read-Only Memory (ROMs), Random Access Memory (RAM), Erasable Programmable Read-Only Memory (EPROM), and a transmission over the Internet.

Further, a design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional microelectronic fabrication techniques are used, data representing a hardware model may be the data specifying the presence or absence of various features on different mask layers for masks used to produce the integrated circuit. In any representation of the design, the data may be stored in any form of a machine-readable medium.

The invention is not limited to the specific embodiments described above. For example, although the embodiments of the invention were described above with reference to video, the technique of dividing the frame into strips and transferring portions of the strip to an on-chip buffer for further on-chip processing may also be applied to still images. Also, any reference to “pixel” is not limited to the example used above of a single, 8-bit value. Accordingly, other embodiments are within the scope of the claims.

What is claimed is:

1. A method comprising:
a) dividing a video frame that is stored in frame buffer memory into a plurality of strips each having a width that is less than one-half a full horizontal width of a display screen on which the video frame is to be displayed, and is an integer multiple of a memory burst width for the memory;
b) transferring a portion of one of the strips from the memory into an on-chip buffer;
c) performing polyphase filtering upon the transferred portion; and
repeating b)-c) with another portion of said one of the strips.

2. The method of claim 1 wherein the video frame is a high definition (HD) video frame.

3. The method of claim 2 wherein the vertical scaling is part of a frame adjustment operation in converting from HD to National Television Standards Committee (NSTC) format.

4. The method of claim 1 wherein the video frame is stored in the memory in raster scan order.

5. The method of claim 4 wherein the portion is transferred into a plurality of line segment memories of the on-chip buffer that are of the memory burst width.

6. A method comprising:
a) transferring via a memory burst transfer a portion of a video frame from memory into an on-chip buffer having a width that is of a memory burst width for the memory; and
b) performing video processing upon the transferred portion.

7. The method of claim 6 wherein the video processing is vertical scaling.

8. The method of claim 7 wherein the video frame is stored in the memory in raster scan order.

9. The method of claim 8 where the transferred portion has a plurality of horizontal lines that are transferred in order from top to bottom or bottom to top.

10. The method of claim 9 wherein the portion is transferred into a plurality of line segment memories of the on-chip buffer that are of the memory burst width.

11. A method comprising:
transferring a video frame that is stored in frame buffer memory into an on-chip buffer that is no wider than a strip width, according to a memory access pattern that treats the frame as a plurality of strips each having a width that is based on a memory bus width for the memory, and transfers the frame one portion of a strip at a time; and
performing video processing sequentially upon each of the transferred portions.

12. The method of claim 11 wherein the video processing is vertical scaling using polyphase filtering.

13. The method of claim 12 wherein the video frame is stored in the memory in raster scan order.

14. The method of claim 13 wherein the transferred portion has a plurality of horizontal line segments, each being of the strip width, that are transferred in order from top to bottom or bottom to top.

15. An integrated circuit (IC) device comprising:
an on-chip buffer to store pixel data of a video frame that is stored in external memory, the buffer having a plurality of line segment memories each being of a width that is one of a cache line width and memory burst width for the external memory, the IC device to accept a portion of the video frame to be transferred from the external memory into the plurality of line segment memories; and
an on-chip video processing polyphase filter having a plurality of taps coupled to the plurality of line segment memories, respectively, to operate upon the transferred portion.

16. The IC device of claim 15 wherein each line segment memory comprises on-chip RAM.

17. The IC device of claim 15 wherein the polyphase filter has n taps where n is greater than two and less than twenty.

18. The IC device of claim 17 wherein the IC device treats the video frame as being partitioned into a plurality of strips running vertically each having a width that is an integer multiple of one of the cache line width and the memory burst width.

19. The IC device of claim 18 wherein the IC device is to repeatedly read portions of a strip from the external memory using memory burst read transactions.

20. The IC device of claim 19 wherein the on-chip buffer is organized into Y, Cr, and Cb groups to store pixel data of the video frame.

21. A system comprising:
a processor;
a cache to store data recently used by the processor;
main memory to store a program that is to be executed by the processor; and
a video post-processing chip to perform frame adjustment upon decoded, uncompressed video that has been requested by the program, the chip to treat each video frame as partitioned into a plurality of strips where each strip has a width that is an integer multiple of one of a cache line width and a memory burst width for the main memory, receive each strip from the main memory, and vertically scale each received strip.

22. The system of claim 21 wherein the main memory has a frame buffer section to store the video frames for transfer to the video post-processing chip.

23. The system of claim 22 wherein the video frames are stored in the frame buffer section in raster scan order.

24. The system of claim 23 wherein the main memory is comprised of random access memory modules.

25. The system of claim 21 wherein the video post-processing chip has an on-chip buffer to store a portion of one of the strips and that is of the same width as the cache line width or the memory burst width.

26. A machine-readable medium comprising instructions stored therein that when executed initiate a plurality of burst memory read transactions to transfer a portion of an image from external memory into an on-chip buffer that is of the same width as a memory burst width of the transactions, and perform polyphase filtering upon the transferred portion.

27. The medium of claim 26 further comprising instructions that repeat the transfer with another portion of the image and perform polyphase filtering upon the transferred another portion.

28. The medium of claim 27 wherein each of said portions is of a width that is an integer multiple of the memory burst width.

29. The medium of claim 28 wherein the width of each portion is as measured along a horizontal line segment of the image.
